(19) United States
(12) Patent Application Publication
(10) Pub. No.: US 2010/0090365 A1
(43) Pub. Date: Apr. 15, 2010

(54) METHOD FOR THE PRODUCTION OF FIBERS

(75) Inventors: Markus Schuette, Osnabrueck (DE); Hauke Malz, Diepholz (DE); Laszlo Szarvas, Ludwigshafen (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, LUDWIGSHAFEN (DE)

(21) Appl. No.: 12/515,423

(22) PCT Filed: Nov. 16, 2007
(86) PCT No.: PCT/EP07/62451

§ 371 Date: May 19, 2009

(30) Foreign Application Priority Data
Nov. 23, 2006 (EP) 06124650.0

(51) Int. Cl. D01D 5/06; C08F 6/00

(52) U.S. Cl. 264/178 F; 528/480

(57) ABSTRACT

A process for producing fibers comprises spinning a solution (I) comprising polyurethane dissolved in ionic liquid into a coagulation bath.

The present invention relates to processes for producing fibers, preferably spandex fibers, preferably by wet spinning a solution (I) comprising polyurethane into a coagulation bath, wherein said solution (I) comprises polyurethane dissolved in ionic liquid. The present invention further provides thus obtainable fibers, preferably spandex fibers. The present invention also relates to processes for dissolving polyurethane and mixtures comprising ionic liquid and also polyurethane dissolved therein. The present invention further relates to the recycling of spandex fibers and also to antistatic spandex fibers comprising ionic liquid.

Elastic fibers of polyurethane have been known for more than 20 years under the name of spandex. These fibers are obtained from a polyol, usually a polytetrahydrofuran, MDI and a chain extender, for example ethylenediamine, propylenediamine or mixtures thereof. Spandex fibers are mainly produced by the wet-spinning process or by the dry-spinning process. Both methods of production are well known to one skilled in the art and have been extensively described. The elastic fibers produced typically have a density range from 10 dtex to 3000 dtex.

The wet-spinning process typically involves reacting a polyurethane prepolymer, formed from polyol and MDI, with the chain extender in solution. The solution is then spun into a liquid coagulation bath. Solidification then ensues through coagulation due to phase separation. Solvent and nonsolvent should be chosen such that they are miscible with each other over the entire concentration range. One example of a pair of liquids currently used in industry is DMF/water; that is, a polyurethane-containing DMF solution is spun into a water bath. The product of this operation is commonly also referred to as wet-spun spandex.

In the dry-spun process, a polyurethane prepolymer formed from polyol and MDI is reacted with the chain extender in solution. DMF and DMAC are examples of solvents used. The solution is subsequently spun into a hot gas. The gas temperature is higher than the boiling temperature of the solvent. The solvent evaporates during spinning and the fiber solidifies.

One problem common to both processes is the use of toxic solvents such as DMF, DMAC, NMP, etc. The wet-spun process generates large amounts of contaminated wastewaters. To reduce the amount of wastewater and to limit solvent requirements, the solvent-water mixtures from the coagulation baths are recycled by distillation. Since, however, azeotrope formation is a frequent occurrence with the solvent-water mixtures, solvent recovery is costly and inconvenient.

Another disadvantage common to both processes is the generation of off-spec fiber packages, for example short rolls or fibers having nonuniform linear densities or mechanical properties. Since spandex fibers, once formed by spinning, are insoluble owing to the stability of the urea bond, some of the reject material may only be good for thermal recovery.

It is an object of the present invention to develop a process for producing fibers which is capable of utilizing starting materials, particularly solvents, which ideally are generally recognized as safe by toxicologists and easy and economical to handle. Moreover, the process should make it possible to recycle off-spec fibers. And the process should ideally be simple and economical to operate.

We have found that this object is achieved by the processes, fibers and mixtures set out at the beginning.

The advantages reside particularly in the use of nontoxic solvents; the easy separation of mixture of solvent (IL) and coagulant (water), since no azeotrope forms; and the possibility of recycling products by dissolving spandex fibers and renewed spinning. The term “spandex” is to be understood as meaning in particular spandex fibers, in particular the definition in Römpp Lexikon Chemie, 10th edition, Georg Thieme Verlag, Stuttgart.

Solution (I) of the present invention is preferably produced by preparing the polyurethane in the ionic liquid. Preferably, a prepolymer can be prepared in particular by reaction of (a) isocyanate with (b) isocyanate-reactive compounds in the ionic liquid in the presence or absence of (c) chain extenders. This prepolymer can subsequently be reacted, preferably spun, preferably with amines generally known for this purpose, preferably aliphatic diamines, particularly ethylenediamine and/or propylenediamine, to form spandex fibers.

Alternatively, and likewise preferable, it is possible to prepare the prepolymer from (a) isocyanate and (b) isocyanate-reactive compounds, in the presence or absence of (c), without a solvent, and then to mix it with the ionic liquid. In this case too, the prepolymer can subsequently be reacted, preferably spun, preferably with amines generally known for this purpose, preferably aliphatic diamines, particularly ethylenediamine and/or propylenediamine, to form spandex fibers.

It is further possible to dissolve spandex, preferably spandex fibers, in the ionic liquid.

Solution (I) can also be produced by dissolving polyurethane, preferably thermoplastic polyurethane, in ionic liquids.

The polyurethane which is dissolved in an ionic liquid may thus comprise
a prepolymer which is subsequently reacted with chain-extending agents (c), preferably amines, more preferably aliphatic diamines and particularly ethylenediamine and/or propylenediamine, to form spandex,
spandex, preferably spandex fibers, or else
thermoplastic polyurethane.

Preferably, the initial step is to use (a) isocyanate, (b) isocyanate-reactive compounds and, if appropriate, (c) to prepare a prepolymer which has isocyanate groups, this prepolymer being subsequently converted, preferably in the presence of ionic liquid, to the spinnable product.

Auxiliary materials (e) may be added to the mixture of prepolymer and ionic liquid.

It is preferable to add chain extenders (c) to the mixture of prepolymer, ionic liquid and, if appropriate, (e) auxiliary materials. The chain extender (c) reacts with the prepolymer to form the spinnable product.

Polyurethane for the purposes of this invention is therefore to be understood as meaning in particular a polymer which is prepared from an (a) isocyanate, (b) isocyanate-reactive compounds and chain extender (c).

The weight ratio of polyurethane and ionic liquid in solution (I) is choosable within wide limits, and is mainly determined by processing properties such as the viscosity. The ratio of ionic liquid to polyurethane is typically between 20:1 and 1:10, preferably between 10:1 and 1:1 and more preferably between 4:1 and 2:1.

The preparation of polyurethane by reaction of (a) isocyanates with (b) isocyanate-reactive compounds, preferably having a number average molecular weight of 500 to 10 000 g/mol, (c) chain-extending agents having a molecular weight of 50 to 499 g/mol, in the presence or absence of (d) catalysts and/or (e) auxiliary materials is well known to one skilled in the art and has been extensively described.

Wet-spun spandex is so called because solution (I) is spun in a coagulation bath.

The components typically used to prepare the polyurethanes—(a), (b), (c) and also, if appropriate, (d) and/or (e)—will now be described by way of example:

As organic isocyanates (a) there may be used generally known aliphatic, cycloaliphatic, araliphatic and/or aromatic isocyanates, preferably diisocyanates, examples being tri-, tetra-, penta-, hexa-, hepta- and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanato-methylcyclohexane (isophorone diisocyanate, IPDI), 1,4- and/or 1,3-bis(isocyanate methyl)cyclohexane (HXDI), 1,4-cyclohexane diisocyanate, 1-methyl-2,4- and/or -2,6-cyclohexane diisocyanate and/or 4,4′-, 2,4′- and 2,2′-dicyclohexylmethane diisocyanate, 2,2′-, 2,4′- and/or 4,4′-diphenylmethane diisocyanate (MDI), 1,5-naphthylene diisocyanate (NDI), 2,4- and/or 2,6-tolylene diisocyanate (TDI), diphenylmethane diisocyanate, 3,3′-dimethyldiphenyl diisocyanate, 1,2-diphenylethane diisocyanate and/or phenylene diisocyanate. 4,4′-MDI is preferably used.

As isocyanate-reactive compounds (b) there may be used the generally known isocyanate-reactive compounds, examples being polyesterols, polyetherols and/or polycarbonate diols, which are usually also subsumed under the term “polyols”, having molecular weights between 500 and 4000 g/mol, preferably between 1000 and 3000 g/mol and particularly between 1500 and 2000 g/mol, and preferably an average functionality between 1.8 and 2.3, preferably 1.9 to 2.2, particularly 2.

Particular preference is given to polytetrahydrofurans having a molecular weight between 1000 g/mol and 3000 g/mol, preferably between 1700 g/mol and 2200 g/mol.

As chain-extending agents (c) there may be used generally known aliphatic, araliphatic, aromatic and/or cycloaliphatic compounds having a molecular weight of 50 to 499, preferably 2-functional compounds, for example diamines and/or alkanediols having 2 to 10 carbon atoms in the alkylene radical, particularly 1,4 butanediol, 1,6 hexanediol and/or di-, tri-, tetra-, penta-, hexa-, hepta-, octa-, nona- and/or decaalkylene glycols having 3 to 8 carbon atoms, preferably the corresponding oligo- and/or polypropylene glycols, in which case mixtures of chain extenders can also be used. Particular preference for use as chain-extending agents is given to aliphatic diamines, particularly ethylenediamine or propylenediamine or mixtures comprising ethylenediamine and propylenediamine.

Suitable catalysts (d) which speed particularly the reaction between the NCO groups of the diisocyanates (a) and the hydroxyl and/or amino groups of the construction components (b) and (c) are the tertiary amines which are known and customary according to the prior art, examples being triethylamine, dimethylcyclohexylamine, N-methylmorpholine, N,N′-dimethylpiperazine, 2-(dimethylaminoethoxy)ethanol, diazabicyclo(2,2,2)octane and the like, and also particularly organic metal compounds such as titanic esters, iron compounds such as for example iron (III) acetylacetonate, tin compounds, for example tin diacetate, tin dioctoate, tin dilaurate or the tin dialkyl salts of aliphatic carboxylic acids such as dibutyltin diacetate, dibutyltin dilaurate and the like. The catalysts are typically used in amounts of 0.0001 to 0.1 part by weight per 100 parts by weight of polyhydroxyl compound (b).

In addition to catalysts (d), it is also possible to add customary auxiliaries and/or additive materials (e) to the construction components (a) to (c). Examples which may be mentioned are blowing agents, surface-active substances, fillers, flame retardants, nucleators, antioxidants, lubricating and demolding aids, dyes and pigments, if appropriate, in addition to the stabilizer mixtures of the present invention, further stabilizers, for example against hydrolysis, light, heat or discoloration, inorganic and/or organic fillers, reinforcing agents and plasticizers/softeners. In one preferred embodiment, component (e) also includes hydrolysis control agents such as for example polymeric and low molecular weight carbodiimides. In a further embodiment, the polyurethane may comprise a phosphorus compound. Phosphorus compounds utilized in a preferred embodiment are organophosphorus compounds of trivalent phosphorus, for example phosphites and phosphonites. Examples of suitable phosphorus compounds are triphenyl phosphite, diphenyl alkyl phosphite, phenyl dialkyl phosphite, tris(nonylphenyl) phosphite, trilauryl phosphite, trioctadecyl phosphite, distearylpentaerythritol diphosphite, tris(2,4-di-tert-butylphenyl) phosphite, diisodecylpentaerythritol diphosphite, di(2,4-di-tert-butylphenyl)pentaerythritol diphosphite, tristearylsorbitol triphosphite, tetrakis-(2,4-di-tert-butylphenyl)-4,4′-biphenylylene diphosphonite, trisisodecyl phosphite, diisodecyl phenyl phosphite and diphenyl isodecyl phosphite, or mixtures thereof.

In addition to the recited components (a), (b) and (c) and also, if appropriate, (d) and (e), it is also possible to use chain regulators, typically having a molecular weight of 31 to 499. Such chain regulators are compounds which have merely one isocyanate-reactive functional group, examples being monofunctional alcohols, monofunctional amines and/or monofunctional polyols. Such chain regulators may be used to adjust a flow property, particularly of TPUs, in a specific manner. Chain regulators may be used in general in an amount of 0 to 5, preferably 0.1 to 1, parts by weight, based on 100 parts by weight of component b), and come under component (c) by definition.

Molecular weights recited herein all have unit [g/mol].

The polyurethane is preferably based on reaction of (a) isocyanate, preferably 4,4′-MDI, with (b) isocyanate-reactive compounds having a molecular weight between 500 g/mol and 10 000 g/mol, and also (c) chain-extending agents preferably having a molecular weight between 50 and 499 g/mol, preferably aliphatic diamines, more preferably ethylenediamine and/or propylenediamine, in the presence or absence of (d) catalysts and/or (e) auxiliary materials.

To adjust fiber hardness, the construction components (b) and (c) can be varied within relatively wide molar ratios. Molar ratios of component (b) to total chain-extenders (c) in the range from 10:1 to 1:10 and particularly in the range from 1:1 to 1:4 will be found advantageous, the hardness of the polyurethanes increasing with increasing (c) content.

The reaction can be carried out at customary characteristics, preferably a characteristic in the range from 900 to 1100 and more preferably at a characteristic in the range from 950 to 1050. The characteristic is defined by the ratio of total isocyanate groups of component (a) in the reaction to the isocyanate-reactive groups, i.e., the active hydrogens, of components (b) and (c). When the characteristic is 100, there is one active hydrogen atom, i.e., one isocyanate-reactive function, on the part of components (b) and (c) per isocyanate group of component (a). At characteristics above 1000, there will be more isocyanate groups than OH groups.

Ionic liquids are common general knowledge and have been extensively described.

The term “ionic liquids” is preferably to be understood as meaning compounds—preferably organic compounds—that comprise at least one cation and at least one anion and wherein at least one cation and/or at least one anion comprises an organic radical.

Ionic liquids preferably have a melting point of less than 180° C. The melting point is more preferably in the range from −50° C. to 150° C., particularly in the range from −20° C. to 120° C. and more particularly below 100° C.

Ionic liquids for the purposes of the present invention are preferably salts of the general formula

(A) salts of the general formula (I)

[A]ₙ⁺[Y]ⁿ⁻ (I),
where n is 1, 2, 3 or 4, [A]⁺ is a quaternary ammonium cation, an oxonium cation, a sulfonium cation or a phosphonium cation and [Y]ⁿ⁻ is a monovalent, divalent, trivalent or tetravalent anion; or
   (B) mixed salts of the general formulae (II)

[A¹]⁺[A²]⁺[Y]ⁿ⁻ (IIa),

where n=2;

[A¹]⁺[A²]⁺[A³]⁺[Y]ⁿ⁻ (IIb),

where n=3; or

[A¹]⁺[A²]⁺[A³]⁺[A⁴]⁺[Y]ⁿ⁻ (IIc),

where n=4 and
where [A¹]⁺, [A²]⁺, [A³]⁺ and [A⁴]⁺ are selected independently from among the groups mentioned for [A]⁺ and [Y]ⁿ⁻ is as defined under (A); or
   (C) mixed salts of the general formulae (III)

[A¹]⁺[A²]⁺[A³]⁺[M¹]⁺[Y]ⁿ⁻ (IIIa),

where n=4;

[A¹]⁺[A²]⁺[M¹]⁺[M²]⁺[Y]ⁿ⁻ (IIIb),

where n=4;

[A¹]⁺[M¹]⁺[M²]⁺[M³]⁺[Y]ⁿ⁻ (IIIc),

where n=4;

[A¹]⁺[A²]⁺[M¹]⁺[Y]ⁿ⁻ (IIId),

where n=3;

[A¹]⁺[M¹]⁺[M²]⁺[Y]ⁿ⁻ (IIIe),

where n=3;

[A¹]⁺[M¹]⁺[Y]ⁿ⁻ (IIIf),

where n=2;

[A¹]⁺[A²]⁺[M⁴]²⁺[Y]ⁿ⁻ (IIIg),

where n=4;

[A¹]⁺[M¹]⁺[M⁴]²⁺[Y]ⁿ⁻ (IIIh),

where n=4;

[A¹]⁺[M⁵]³⁺[Y]ⁿ⁻ (IIIi),

where n=4; or

[A¹]⁺[M⁴]²⁺[Y]ⁿ⁻ (IIIj),

where n=3 and
where [A¹]⁺, [A²]⁺ and [A³]⁺ are selected independently from among the groups mentioned for [A]⁺; [Y]ⁿ⁻ is as defined under (A); and [M¹]⁺, [M²]⁺ and [M³]⁺ are monovalent metal cations, [M⁴]²⁺ are divalent metal cations and [M⁵]³⁺ are trivalent metal cations.

Compounds suitable for the formation of the cation [A]⁺ of ionic liquids are known, for example, from DE 102 02 838 A1. Thus, such compounds can comprise oxygen, phosphorus, sulfur or in particular nitrogen atoms, for example at least one nitrogen atom, preferably from 1 to 10 nitrogen atoms, particularly preferably from 1 to 5 nitrogen atoms, very particularly preferably from 1 to 3 nitrogen atoms and in particular 1 or 2 nitrogen atoms. If appropriate, further heteroatoms such as oxygen, sulfur or phosphorus atoms can also be comprised. The nitrogen atom is a suitable carrier of the positive charge in the cation of the ionic liquid, from which a proton or an alkyl radical can then go over in equilibrium to the anion to produce an electrically neutral molecule.

When the nitrogen atom is the carrier of the positive charge in the cation of the ionic liquid, a cation can firstly be produced by quaternization of the nitrogen atom of, for instance, an amine or nitrogen heterocycle in the synthesis of the ionic liquids. Quaternization can be effected by alkylation of the nitrogen atom. Depending on the alkylation reagent used, salts having different anions are obtained. In cases in which it is not possible to form the desired anion in the quaternization itself, this can be brought about in a further step of the synthesis. Starting from, for example, an ammonium halide, the halide can be reacted with a Lewis acid, forming a complex anion from the halide and Lewis acid. As an alternative, replacement of a halide ion by the desired anion is possible. This can be achieved by addition of a metal salt with precipitation of the metal halide formed, by means of an ion exchanger or by displacement of the halide ion by a strong acid (with liberation of the hydrogen halide). Suitable methods are described, for example, in Angew. Chem. 2000, 112, pp. 3926-3945, and the references cited therein.

Suitable alkyl radicals by means of which the nitrogen atom in the amines or nitrogen heterocycles can, for example, be quaternized are C₁-C₁₈alkyl, preferably C₁-C₁₀-alkyl, particularly preferably C₁-C₆-alkyl and very particularly preferably methyl. The alkyl group can be unsubstituted or have one or more identical or different substituents.

Preference is given to compounds which comprise at least one five- or six-membered heterocycle, in particular a five-membered heterocycle, which has at least one nitrogen atom and also, if appropriate, an oxygen or sulfur atom. Particular preference is likewise given to compounds which comprise at least one five- or six-membered heterocycle which has one, two or three nitrogen atoms and a sulfur or oxygen atom, very particularly preferably compounds having two nitrogen atoms. Further preference is given to aromatic heterocycles.

Particularly preferred compounds have a molecular weight below 1000 g/mol, very particularly preferably below 500 g/mol.

Furthermore, preference is given to cations selected from among the compounds of the formulae (IVa) to (IVw),

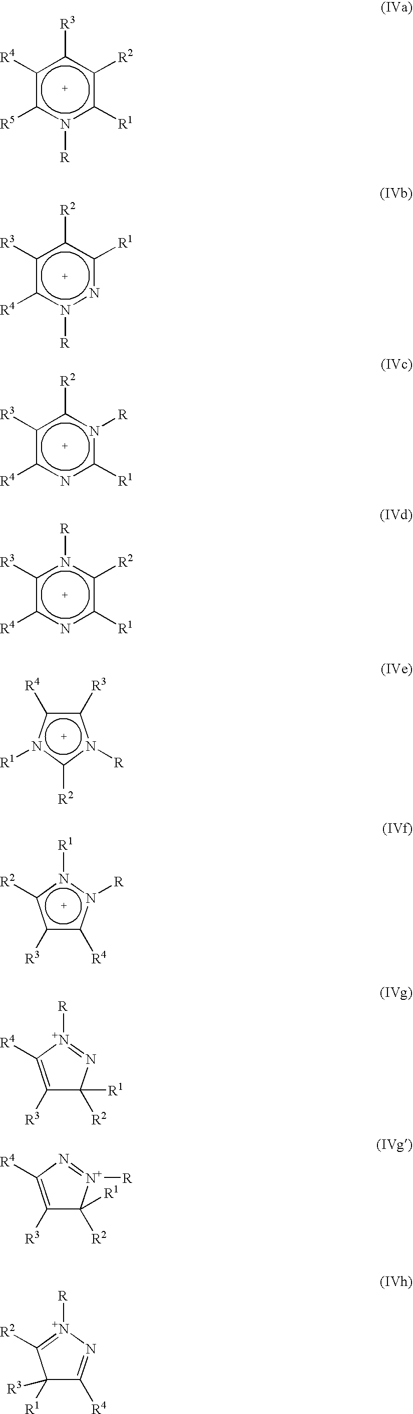

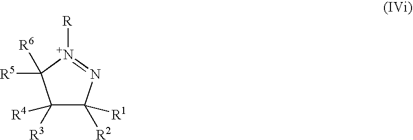

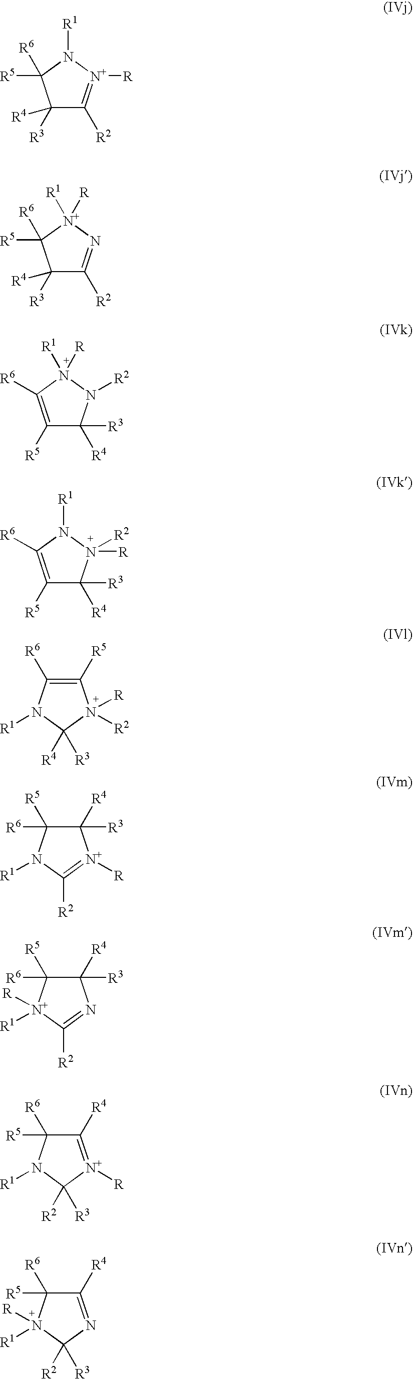

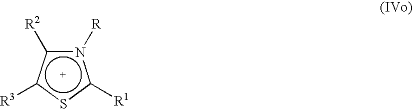

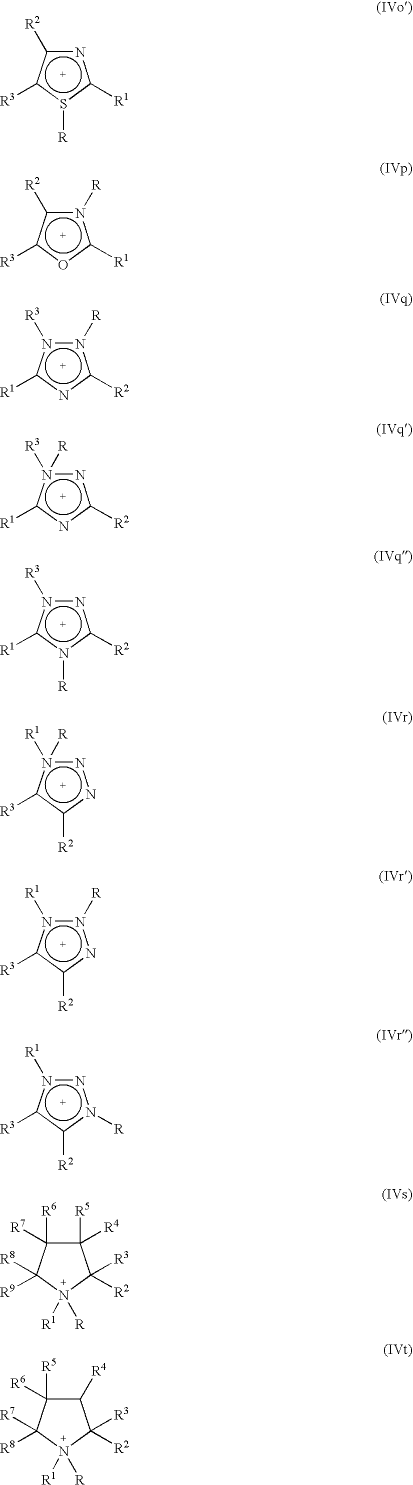

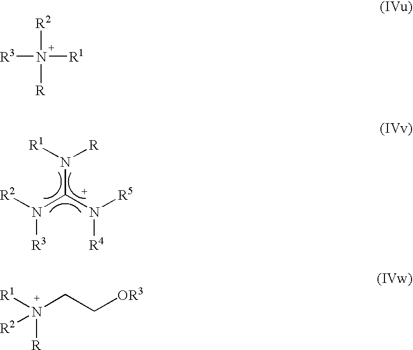

and oligomers comprising these structures.

Further suitable cations are compounds of the general formulae (IVx) and (IVy)

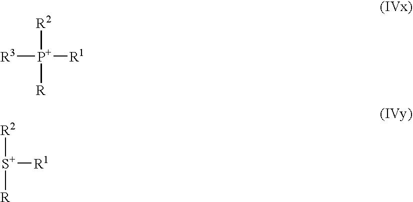

and oligomers comprising these structures.

In the abovementioned formulae (IVa) to (IVy)
the radical R is hydrogen or a carbon-comprising organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or suitable functional groups; and
the radicals R¹ to R⁹ are each, independently of one another, hydrogen, a sulfo group or a carbon-comprising organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or suitable functional groups, where the radicals R¹ to R⁹ which are bound to a carbon atom (and not to a heteroatom) in the formulae (IV) mentioned above are additionally able to be halogen or a functional group; or
two adjacent radicals from the group consisting of R¹ to R⁹ may together also form a divalent, carbon-comprising organic, saturated or unsaturated, acyclic or cyclic, aliphatic, aromatic or araliphatic radical which has from 1 to 30 carbon atoms and may be unsubstituted or be interrupted or substituted by from 1 to 5 heteroatoms or suitable functional groups.

In the definitions of the radicals R and R¹ to R⁹, possible heteroatoms are in principle all heteroatoms which are able to formally replace a —CH₂— group, a —CH═ group, a —C≡ group or a ═C═ group. If the carbon-comprising radical comprises heteroatoms, then oxygen, nitrogen, sulfur, phosphorus and silicon are preferred. Preferred groups are, in particular, —O—, —S—, —SO—, —SO₂—, —NR′—, —N═, —PR′—, —PR′₂ and —SiR′₂—, where the radicals R′ are the remaining part of the carbon-comprising radical. In the cases in which the radicals R¹ to R⁹ are bound to a carbon atom (and not a heteroatom) in the abovementioned formulae (IV), they can also be bound directly via the heteroatom.

Suitable functional groups are in principle all functional groups which can be bound to a carbon atom or a heteroatom. Suitable examples are —NR₂′, and —CN (cyano). Functional groups and heteroatoms can also be directly adjacent, so that combinations of a plurality of adjacent atoms, for instance —O— (ether), —S— (thioether), —COO— (ester) or —CONR′— (tertiary amide), are also comprised, for example di-(C₁-C₄-alkyl)amino, C₁-C₄-alkyloxycarbonyl or C₁-C₄-alkyloxy. The radicals R′ are the remaining part of the carbon-comprising radical.

As halogens, mention may be made of fluorine, chlorine, bromine and iodine.

The radical R is preferably
unbranched or branched C₁-C₁₈-alkyl which may be unsubstituted or substituted by one or more halogen, phenyl, cyano and has a total of from 1 to 20 carbon atoms, for example methyl, ethyl, 1-propyl, 2-propyl, 1-butyl, 2-butyl, 2-methyl-1-propyl (isobutyl), 2-methyl-2-propyl (tert-butyl), 1-pentyl, 2-pentyl, 3-pentyl, 2-methyl-1-butyl, 3-methyl-1-butyl, 2-methyl-2-butyl, 3-methyl-2-butyl, 2,2-di-methyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, 1-heptyl, 1-octyl, 1-nonyl, 1-decyl, 1-undecyl, 1-dodecyl, 1-tetradecyl, 1-hexadecyl, 1-octadecyl, benzyl, 3-phenylpropyl, 2-cyanoethyl, 2-(methoxycarbonyl)ethyl, 2-(ethoxycarbonyl)ethyl, 2-(n-butoxycarbonyl)ethyl, trifluoromethyl, difluoromethyl, fluoromethyl, pentafluoroethyl, heptafluoropropyl, heptafluoroisopropyl, nonafluorobutyl, nonafluoroisobutyl, undecylfluoropentyl and undecylfluoroisopentyl;
glycols, butylene glycols and oligomers thereof having from 1 to 100 units, with all the above groups bearing a C₁-C₈-alkyl radical as end group, for example R^{A}O—(CHR^{B}—CH₂—O)ₙ—CHR^{B}—CH₂— or R^{A}O—(CH₂CH₂CH₂CH₂O)ₙ—CH₂CH₂CH₂CH₂O— where R^{A} and R^{B} are each preferably methyl or ethyl and n is preferably 0 to 3, in particular 3-oxabutyl, 3-oxapentyl, 3,6-dioxaheptyl, 3,6-dioxaoctyl, 3,6,9-trioxadecyl, 3,6,9-trioxaundecyl, 3,6,9,12-tetraoxamidecyl and 3,6,9,12-tetraoxatetradecyl;
vinyl;
1-propen-1-yl, 1-propen-2-yl and 1-propen-3-yl; and
N,N-di-C₁-C₆-alkylamino such as N,N-dimethylamino and N,N-diethylamino.

The radical R is particularly preferably unbranched and unsubstituted C₁-C₁₈-alkyl, such as methyl, ethyl, 1-propyl, 1-butyl, 1-pentyl, 1-hexyl, 1-heptyl, 1-octyl, 1-decyl, 1-dodecyl, 1-tetradecyl, 1-hexadecyl, 1-octadecyl, in particular methyl, ethyl, 1-butyl and 1-octyl, or CH₃O—(CH₂CH₂O)ₙ—CH₂CH₂— and CH₃CH₂O—(CH₂CH₂O)ₙ—CH₂CH₂— where n is 0 to 3.

Preference is given to the radicals R¹, to R⁹ each being, independently of one another,
hydrogen;
halogen;
a suitable functional group;
C₁-C₁₈-alkyl which may optionally be substituted by suitable functional groups, aryl, alkyl, aryloxy, alkyloxy, halogen, heteroatoms and/or heterocycles and/or be interrupted by one or more oxygen and/or sulfur atoms and/or one or more substituted or unsubstituted imino groups;
C₂-C₁₈-alkenyl which may optionally be substituted by suitable functional groups, aryl, alkyl, aryloxy, alkyloxy, halogen, heteroatoms and/or heterocycles and/or be interrupted by one or more oxygen and/or sulfur atoms and/or one or more substituted or unsubstituted imino groups;
C₆-C₁₂-aryl which may optionally be substituted by suitable functional groups, aryl, alkyl, aryloxy, alkyloxy, halogen, heteroatoms and/or heterocycles;
C₅-C₁₂-cycloalkyl which may optionally be substituted by suitable functional groups, aryl, alkyl, aryloxy, alkyloxy, halogen, heteroatoms and/or heterocycles;
C₅-C₁₂-cycloalkenyl which may optionally be substituted by suitable functional groups, aryl, alkyl, aryloxy, alkyloxy, halogen, heteroatoms and/or heterocycles; or
a five- or six-membered, oxygen-, nitrogen- and/or sulfur-comprising heterocycle which may optionally be substituted by suitable functional groups, aryl, alkyl, aryloxy, alkyloxy, halogen, heteroatoms and/or heterocycles; or
   two adjacent radicals combine with the atoms to which they are attached to form
an unsaturated, saturated or aromatic ring which may optionally be substituted by suitable functional groups, aryl, alkyl, aryloxy, alkyloxy, halogen, heteroatoms and/or heterocycles and may optionally be interrupted by one or more oxygen and/or sulfur atoms and/or one or more substituted or unsubstituted imino groups.

C₁-C₁₈-alkyl which may optionally be substituted by suitable functional groups, aryl, alkyl, aryloxy, alkyloxy, halogen, heteroatoms and/or heterocycles is preferably methyl, ethyl, 1-propyl, 2-propyl, 1-butyl, 2-butyl, 2-methyl-1-propyl (isobutyl), 2-methyl-2-propyl (tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, 2-ethylhexyl, 2,4,4-trimethylpentyl, 1,1,3,3-tetramethylbutyl, 1-nonyl, 1-decyl, 1-undecyl, 1-dodecyl, 1-tridecyl, 1-tetradecyl, 1-pentadecyl, 1-hexadecyl, 1-heptadecyl, 1-octadecyl, cyclopentylmethyl, 2-cyclopentylethyl, 3-cyclopentylpropyl, cyclohexylmethyl, 2-cyclohexylethyl, 3-cyclohexylpropyl, benzyl (phenylmethyl), diphenylmethyl (benzhydryl), triphenylmethyl, 1-phenylethyl, 2-phenylethyl, 3-phenylpropyl, α,α-dimethylbenzyl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonylethyl, 2-ethoxycarbonylethyl, 2-butoxycarbonylpropyl, 1,2-di-(methoxycarbonyl)ethyl, methoxy, ethoxy, 1,3-dioxolan-2-yl, 1,3-dioxan-2-yl, 2-methyl-1,3-dioxolan-2-yl, 4-methyl-1,3-dioxolan-2-yl, 2-dimethylaminoethyl, 2-dimethylaminopropyl, 3-dimethylaminopropyl, 4-dimethylaminobutyl, 6-dimethylaminohexyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl, 6-ethoxyhexyl, CₙF_{2(n-a)+(1-b)}H_{2a+b} where n is from 1 to 30, 0≦a≦n and b=0 or 1 (for example CF₃, C₂F₅, CH₂CH₂—C₍ₙ₋₂₎F₂₍ₙ₋₂₎₊₁, C₆F₁₃, C₈F₁₇, C₁₀F₂₁, C₁₂F₂₅), chloromethyl, 2-chloroethyl, trichloromethyl, 1,1-dimethyl-2-chloroethyl, methoxymethyl, 2-butoxyethyl, diethoxymethyl, diethoxyethyl, 2-isopropoxyethyl, 2-butoxypropyl, 2-octyloxyethyl, 2-methoxyisopropyl, 2-(methoxycarbonyl)methyl, 2-(ethoxycarbonyl)methyl, 2-(n-butoxycarbonyl)methyl, butylthiomethyl, 2-dodecylthioethyl, 2-phenylthioethyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-dioxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

C₂-C₁₈-alkenyl which may optionally be substituted by suitable functional groups, aryl, alkyl, aryloxy, alkyloxy, halogen, heteroatoms and/or heterocycles and/or be interrupted by one or more oxygen and/or sulfur atoms and/or one or more substituted or unsubstituted imino groups is preferably vinyl, 2-propenyl, 3-butenyl, cis-2-butenyl, trans-2-butenyl or CₙF_{2(n-a)-(1-b)}H_{2a-b} where n≦30, 0≦a≦n and b=0 or 1.

C₆-C₁₂-aryl which may optionally be substituted by suitable functional groups, aryl, alkyl, aryloxy, alkyloxy, halogen, heteroatoms and/or heterocycles is preferably phenyl, tolyl, xylyl, α-naphthyl, β-naphthyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2-nitrophenyl, 4-nitrophenyl, 2,4-dinitrophenyl, 2,6-dinitrophenyl, 4-dimethylaminophenyl, 4-acetylphenyl, methoxyethylphenyl, ethoxymethylphenyl, methylthiophenyl, isopropylthiophenyl or tert-butylthiophenyl or C₆F₍₅₋ₐ₎Hₐ where 0≦a≦5.

C₅-C₁₂-cycloalkyl which may optionally be substituted by suitable functional groups, aryl, alkyl, aryloxy, alkyloxy, halogen, heteroatoms and/or heterocycles is preferably cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl, CₙF_{2(n-a)-(1-b)}H_{2a-b} where n≦30, 0≦a≦n and b=0 or 1, or a saturated or unsaturated bicyclic system such as norbornyl or norbornenyl.

C₅- to C₁₂-cycloalkenyl which may optionally be substituted by suitable functional groups, aryl, alkyl, aryloxy, alkyloxy, halogen, heteroatoms and/or heterocycles is preferably 3-cyclopentenyl, 2-cyclohexenyl, 3-cyclohexenyl, 2,5-cyclohexadienyl or CₙF_{2(n-a)-3(1-b)}H_{2a-3b} where n≦30, 0≦a≦n and b=0 or 1.

A five- or six-membered, oxygen-, nitrogen- and/or sulfur-containing heterocycle which may optionally be substituted by suitable functional groups, aryl, alkyl, aryloxy, alkyloxy, halogen, heteroatoms and/or heterocycles is preferably furyl, thiophenyl, pyrryl, pyridyl, indolyl, benzoxazolyl, dioxolyl, dioxyl, benzimidazolyl, benzthiazolyl, dimethylpyridyl, methylquinolyl, dimethylpyrryl, methoxyfuryl, dimethoxypyridyl or difluoropyridyl.

When two adjacent radicals together form an unsaturated, saturated or aromatic ring which may optionally be substituted by suitable functional groups, aryl, alkyl, aryloxy, alkyloxy, halogen, heteroatoms and/or heterocycles and may optionally be interrupted by one or more oxygen and/or sulfur atoms and/or one or more substituted or unsubstituted imino groups, they preferably form 1,3-propylene, 1,4-butylene, 1,5-pentylene, 2-oxa-1,3-propylene, 1-oxa-1,3-propylene, 2-oxa-1,3-propylene, 1-oxa-1,3-propenylene, 3-oxa-1,5-pentylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene.

When the abovementioned radicals comprise oxygen and/or sulfur atoms and/or substituted or unsubstituted imino groups, the number of oxygen and/or sulfur atoms and/or imino groups is not subject to any restrictions. In general, there will be no more than 5 in the radical, preferably no more than 4 and very particularly preferably no more than 3.

If the abovementioned radicals comprise heteroatoms, there is generally at least one carbon atom, preferably at least two carbon atoms, between any two heteroatoms.

Particular preference is given to the radicals R¹ to R⁹ each being, independently of one another,
hydrogen;
unbranched or branched C₁-C₁₈-alkyl which may be unsubstituted or substituted by one or more halogen, phenyl, cyano, and/or C₁-C₆-alkoxycarbonyl groups and has a total of from 1 to 20 carbon atoms, for example methyl, ethyl, 1-propyl, 2-propyl, 1-butyl, 2-butyl, 2-methyl-1-propyl (isobutyl), 2-methyl-2-propyl (tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, 1-heptyl, 1-octyl, 1-nonyl, 1-decyl, 1-undecyl, 1-dodecyl, 1-tetradecyl, 1-hexadecyl, 1-octadecyl, benzyl, 3-phenylpropyl, 2-cyanoethyl, 2-(methoxycarbonyl)ethyl, 2-(ethoxycarbonyl)ethyl, 2-(n-butoxycarbonyl)ethyl, trifluoromethyl, difluoromethyl, fluoromethyl, pentafluoroethyl, heptafluoropropyl, heptafluoroisopropyl, nonafluorobutyl, nonafluoroisobutyl, undecylfluoropentyl and undecylfluoroisopentyl;
glycols, butylene glycols and oligomers thereof having from 1 to 100 units, with all the above groups bearing a C₁-C₈-alkyl radical as end group, for example R^{A}O—(CHR^{B}—CH₂—O)ₙ—CHR^{B}—CH₂— or R^{A}O—(CH₂CH₂CH₂CH₂O)ₙ—CH₂CH₂CH₂CH₂O— where R^{A} and R^{B} are each preferably methyl or ethyl and n is preferably 0 to 3, in particular 3-oxabutyl, 3-oxapentyl, 3,6-dioxaheptyl, 3,6-dioxaoctyl, 3,6,9-trioxadecyl, 3,6,9-trioxaundecyl, 3,6,9,12-tetraoxamidecyl and 3,6,9,12-tetraoxatetradecyl;
vinyl;
1-propen-1yl, 1-propen-2-yl and 1-propen-3yl; and
N,N-di-C₁-C₆-alkylamino, such as N,N-dimethylamino and N,N-diethylamino,
   where, when IIIw is III, then R³ is not hydrogen.

Very particular preference is given to the radicals R¹ to R⁹ each being, independently of one another, hydrogen or C₁-C₁₈-alkyl such as methyl, ethyl, 1-butyl, 1-pentyl, 1-hexyl, 1-heptyl, 1-octyl, phenyl, 2-cyanoethyl, 2-(methoxycarbonyl)ethyl, 2-(ethoxycarbonyl)ethyl, 2-(n-butoxycarbonyl)ethyl, N,N-dimethylamino, N,N-diethylamino, chlorine or CH₃O—(CH₂CH₂O)ₙ—CH₂CH₂— and CH₃CH₂O—(CH₂CH₂O)ₙ—CH₂CH₂— where n is from 0 to 3,

where, when IIIw is III, then R³ is not hydrogen.

Very particularly preferred pyridinium ions (IVa) are those in which
one of the radicals R¹ to R⁵ is methyl, ethyl or chlorine and the remaining radicals R¹ to R⁵ are each hydrogen;
R³ is dimethylamino and the remaining radicals R¹, R², R⁴ and R⁵ are each hydrogen;
all radicals R¹ to R⁵ are hydrogen;
R¹ and R² or R² and R³ in 1,4-buta-1,3-dienylene and the remaining radicals R¹, R², R⁴ and R⁵ are each hydrogen;
   and in particular those in which
R¹ to R⁵ are each hydrogen; or
one of the radicals R¹ to R⁵ is methyl or ethyl and the remaining radicals R¹ to R⁵ are each hydrogen.

As very particularly preferred pyridinium ions (IVa), mention may be made of 1-methylpyridinium, 1-ethylpyridinium, 1-(1-butyl)pyridinium, 1-(1-hexyl)pyridinium, 1-(1-octyl)pyridinium, 1-(1-hexyl)pyridinium, 1-(1-octyl)pyridinium, 1-(1-dodecyl)pyridinium, 1-(1-tetradecyl)pyridinium, 1-(1-hexadecyl)pyridinium, 1,2-dimethylpyridinium, 1-ethyl-2-methylpyridinium, 1-(1-butyl)-2-methylpyridinium, 1-(1-hexyl)-2-methylpyridinium, 1-(1-octyl)-2-methylpyridinium, 1-(1-dodecyl)-2-methylpyridinium, 1-(1-tetradecyl)-2-methylpyridinium, 1-(1-hexadecyl)-2-methylpyridinium, 1-methyl-2-ethylpyridinium, 1,2-diethylpyridinium, 1-(1-butyl)-2-ethylpyridinium, 1-(1-hexyl)-2-ethylpyridinium, 1-(1-octyl)-2-ethylpyridinium, 1-(1-dodecyl)-2-ethylpyridinium, 1-(1-tetradecyl)-2-ethylpyridinium, 1-(1-hexadecyl)-2-ethylpyridinium, 1,2-dimethyl-5-ethylpyridinium, 1,5-diethyl-2-methylpyridinium, 1-(1-butyl)-2-methyl-3-ethylpyridinium, 1-(1-hexyl)-2-methyl-3-ethylpyridinium and 1-(1-octyl)-2-methyl-3-ethyl-pyridinium, 1-(1-dodecyl)-2-methyl-3-ethylpyridinium, 1-(1-tetradecyl)-2-methyl-3-ethylpyridinium and 1-(1-hexadecyl)-2-methyl-3-ethylpyridinium.

Very particularly preferred pyridazinium ions (IVb) are those in which
R¹ to R⁴ are each hydrogen; or
one of the radicals R¹ to R⁴ is methyl or ethyl and the remaining radicals R¹ to R⁴ are each hydrogen.

Very particularly preferred pyridinium ions (IVc) are those in which
R¹ is hydrogen, methyl or ethyl and R² to R⁴ are each, independently of one another, hydrogen or methyl; or
R¹ is hydrogen, methyl or ethyl, R² and R⁴ are each methyl and R³ is hydrogen.

Very particularly preferred pyrazinium ions (IVd) are those in which
R¹ is hydrogen, methyl or ethyl and R² to R⁴ are each, independently of one another, hydrogen or methyl;
R¹ is hydrogen, methyl or ethyl, R² and R⁴ are each methyl and R³ is hydrogen;
R¹ to R⁴ are each methyl; or
R¹ to R⁴ are each hydrogen.

Very particularly preferred imidazolium ions (IVe) are those in which
R¹ is hydrogen, methyl, ethyl, 1-propyl, 1-butyl, 1-pentyl, 1-hexyl, 1-octyl, or 2-cyanoethyl and R² to R⁴ are each, independently of one another, hydrogen, methyl or ethyl.

As very particularly preferred imidazolium ions (IVe), mention may be made of 1-methylimidazolium, 1-ethylimidazolium, 1-(1-butyl)imidazolium, 1-(1-octyl)imidazolium, 1-(1-dodecyl)imidazolium, 1-(1-tetradecyl)imidazolium, 1-(1-hexadecyl)imidazolium, 1,3-dimethylimidazolium, 1-ethyl-3-methylimidazolium, 1-(1-butyl)-3-methylimidazolium, 1-(1-butyl)-3-ethylimidazolium, 1-(1-hexyl)-3-methyl-imidazolium, 1-(1-hexyl)-3-ethylimidazolium, 1-(1-hexyl)-3-butylimidazolium, 1-(1-octyl)-3-methylimidazolium, 1-(1-octyl)-3-ethylimidazolium, 1-(1-octyl)-3-butylimidazolium, 1-(1-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazolium, 1-(1-tetradecyl)-3-ethylimidazolium, 1-(1-tetradecyl)-3-butylimidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butylimidazolium, 1-(1-hexadecyl)-3-octylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium, 1-(1-octyl)-2,3-dimethylimidazolium, 1,4-dimethylimidazolium, 1,3,4-trimethylimidazolium, 1,4-dimethyl-3-ethylimidazolium, 3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium and 1-(prop-1-en-3-yl)-3-methylimidazolium.

Very particularly preferred pyrazolium ions (IVf), (IVg) and (IVg′) are those in which
R¹ is hydrogen, methyl or ethyl and R² to R⁴ are each, independently of one another, hydrogen or methyl.

Very particularly preferred pyrazolium ions (IVh) are those in which
R¹ to R⁴ are each, independently of one another, hydrogen or methyl.

Very particularly preferred 1-pyrazolinium ions (IVi) are those in which
R¹ to R⁶ are each, independently of one another, hydrogen or methyl.

Very particularly preferred 2-pyrazolinium ions (IVj) and (IVj′) are those in which
R¹ is hydrogen, methyl, ethyl or phenyl and R² to R⁶ are each, independently of one another, hydrogen or methyl.

Very particularly preferred 3-pyrazolinium ions (IVk) and (IVk′) are those in which
R¹ and R² are each, independently of one another, hydrogen, methyl, ethyl or phenyl and R³ to R⁶ are each, independently of one another, hydrogen or methyl.

Very particularly preferred imidazolinium ions (IVl) are those in which
R¹ and R² are each, independently of one another, hydrogen, methyl, ethyl, 1-butyl or phenyl, R³ and R⁴ are each, independently of one another, hydrogen, methyl or ethyl and R⁵ and R⁶ are each, independently of one another, hydrogen or methyl.

Very particularly preferred imidazolinium ions (IVm) and (IVm′) are those in which
R¹ and R² are each, independently of one another, hydrogen, methyl or ethyl and R³ to R⁶ are each, independently of one another, hydrogen or methyl.

Very particularly preferred imidazolinium ions (IVn) and (IVn′) are those in which
R¹ to R³ are each, independently of one another, hydrogen, methyl or ethyl and R⁴ to R⁶ are each, independently of one another, hydrogen or methyl.

Very particularly preferred thiazolium ions (IVo) and (IVo′) and oxazolium ions (IVp) are those in which
R¹ is hydrogen, methyl, ethyl or phenyl and R² and R³ are each, independently of one another, hydrogen or methyl.

Very particularly preferred 1,2,4-triazolium ions (IVq), (IVq′) and (IVq″) are those in which
R¹ and R² are each, independently of one another, hydrogen, methyl, ethyl or phenyl and R³ is hydrogen, methyl or phenyl.

Very particularly preferred 1,2,3-triazolium ions (IVr), (IVr′) and (IVr″) are those in which
R¹ is hydrogen, methyl or ethyl and R² and R³ are each, independently of one another, hydrogen or methyl or R² and R³ are together 1,4-buta-1,3-dienylene.

Very particularly preferred pyrrolidinium ions (IVs) are those in which
R¹ is hydrogen, methyl, ethyl or phenyl and R² to R⁹ are each, independently of one another, hydrogen or methyl.

Very particularly preferred imidazolidinium ions (IVt) are those in which
R¹ and R⁴ are each, independently of one another, hydrogen, methyl, ethyl or phenyl and R² and R³ and also R⁵ to R⁸ are each, independently of one another, hydrogen or methyl.

Very particularly preferred ammonium ions (IVu) are those in which
R¹ to R³ are each, independently of one another, C₁-C₁₈-alkyl; or
R¹ and R² are together 1,5-pentylene or 3-oxa-1,5-pentylene and R³ is C₁-C₁₈-alkyl or 2-cyanoethyl.

As very particularly preferred ammonium ions (IVu), mention may be made of methyltri(1-butyl)ammonium, N,N-dimethylpiperidinium and N,N-dimethylmorpholinium.

Examples of tertiary amines from which the quaternary ammonium ions of the general formula (IVu) are derived by quaternization with the radicals R mentioned are diethyl-n-butylamine, diethyl-tert-butylamine, diethyl-n-pentylamine, diethyl-hexylamine, diethyl-octylamine, diethyl(2-ethylhexyl)amine, di-n-propylbutylamine, di-n-propyl-n-pentylamine, di-n-propylhexylamine, di-n-propyloctylamine, di-n-propyl(2-ethylhexyl)amine, diisopropylethylamine, diisopropyl-n-propylamine, diisopropyl-butylamine, diisopropylpentylamine, diisopropylhexylamine, diisopropyloctylamine, diisopropyl(2-ethylhexyl)amine, di-n-butylethylamine, di-n-butyl-n-propylamine, di-n-butyl-n-pentylamine, di-n-butylhexylamine, di-n-butyloctylamine, di-n-butyl(2-ethylhexyl)amine, N-n-butylpyrrolidine, N-sec-butylpyrrolidine, N-tert-butylpyrrolidine, N-n-pentylpyrrolidine, N,N-dimethylcyclohexylamine, N,N-diethylcyclohexylamine, N,N-di-n-butylcyclohexylamine, N-n-propylpiperidine, N-isopropylpiperidine, N-n-butylpiperidine, N-sec-butylpiperidine, N-tert-butylpiperidine, N-n-pentylpiperidine, N-n-butylmorpholine, N-sec-butylmorpholine, N-tert-butylmorpholine, N-n-pentylmorpholine, N-benzyl-N-ethylaniline, N-benzyl-N-n-propylaniline, N-benzyl-N-isopropylaniline, N-benzyl-N-n-butylaniline, N,N-dimethyl-p-toluidine, N,N-diethyl-p-toluidine, N,N-di-n-butyl-p-toluidine, diethylbenzylamine, di-n-propylbenzylamine, di-n-butylbenzylamine, diethylphenylamine, di-n-Propylphenylamine and di-n-butylphenylamine.

Preferred quaternary ammonium salts of the general formula (IVu) are those which can be derived from the following tertiary amines by quaternization by means of the radicals R mentioned, e.g. diisopropylethylamine, diethyl-tert-butylamine, diisopropylbutylamine, di-n-butyl-n-pentylamine, N,N-di-n-butylcyclohexylamine and tertiary amines derived from pentyl isomers.

Particularly preferred tertiary amines are di-n-butyl-n-pentylamine and tertiary amines derived from pentyl isomers. A further preferred tertiary amine which has three identical radicals is triallylamine.

Very particularly preferred guanidinium ions (IVv) are those in which
R¹ to R⁵ are each methyl.

As a very particularly preferred guanidinium ion (IVv), mention may be made of N,N,N′,N′,N″,N″-hexamethylguanidinium.

Very particularly preferred cholinium ions (IVw) are those in which
R¹ and R² are each, independently of one another, methyl, ethyl, 1-butyl or 1-octyl and R³ is methyl or ethyl;
R¹ is methyl, ethyl, 1-butyl or 1-octyl, R² is a —CH₂—CH₂—OR⁴ group and R³ and R⁴ are each, independently of one another, methyl or ethyl; or
R¹ is a —CH₂—CH₂—OR⁴ group, R² is a —CH₂—CH₂—OR⁵ group and R³ to R⁵ are each, independently of one another, methyl or ethyl.

Particularly preferred cholinium ions (IVw) are those in which R³ is selected from among methyl, ethyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl and 14-ethoxy-5,10-oxatetradecyl.

Very particularly preferred phosphonium ions (IVx) are those in which
R¹ to R³ are each, independently of one another, C₁-C₁₈-alkyl, in particular butyl, isobutyl, 1-hexyl or 1-octyl.

Among the abovementioned heterocyclic cations, preference is given to the pyridinium ions, pyrazolinium ions, pyrazolium ions and the imidazolinium ions and the imidazolium ions. Preference is also given to ammonium ions.

Particular preference is given to 1-methylpyridinium, 1-ethylpyridinium, 1-(1-butyl)pyridinium, 1-(1-hexyl)pyridinium, 1-(1-octyl)pyridinium, 1-(1-hexyl)pyridinium, 1-(1-octyl)pyridinium, 1-(1-dodecyl)pyridinium, 1-(1-tetradecyl)pyridinium, 1-(1-hexadecyl)pyridinium, 1,2-dimethylpyridinium, 1-ethyl-2-methylpyridinium, 1-(1-butyl)-2-methylpyridinium, 1-(1-hexyl)-2-methylpyridinium, 1-(1-octyl)-2-methylpyridinium, 1-(1-dodecyl)-2-methylpyridinium, 1-(1-tetradecyl)-2-methylpyridinium, 1-(1-hexadecyl)-2-methylpyridinium, 1-methyl-2-ethylpyridinium, 1,2-diethylpyridinium, 1-(1-butyl)-2-ethylpyridinium, 1-(1-hexyl)-2-ethylpyridinium, 1-(1-octyl)-2-ethylpyridinium, 1-(1-dodecyl)-2-ethylpyridinium, 1-(1-tetradecyl)-2-ethylpyridinium, 1-(1-hexadecyl)-2-ethylpyridinium, 1,2-dimethyl-5-ethylpyridinium, 1,5-diethyl-2-methylpyridinium, 1-(1-butyl)-2-methyl-3-ethylpyridinium, 1-(1-hexyl)-2-methyl-3-ethylpyridinium, 1-(1-octyl)-2-methyl-3-ethylpyridinium, 1-(1-dodecyl)-2-methyl-3-ethylpyridinium, 1-(1-tetradecyl)-2-methyl-3-ethylpyridinium, 1-(1-hexadecyl)-2-methyl-3-ethylpyridinium, 1-methylimidazolium, 1-ethylimidazolium, 1-(1-butyl)-imidazolium, 1-(1-octyl)-imidazolium, 1-(1-dodecyl)imidazolium, 1-(1-tetradecyl)imidazolium, 1-(1-hexadecyl)imidazolium, 1,3-dimethylimidazolium, 1-ethyl-3-methylimidazolium, 1-(1-butyl)-3-methylimidazolium, 1-(1-hexyl)-3-methylimidazolium, 1-(1-octyl)-3-methylimidazolium, 1-(1-dodecyl)-3-methylimidazolium, 1-(1-tetradecyl)-3-methylimidazolium, 1-(1-hexadecyl)-3-methylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium and 1-(1-octyl)-2,3-dimethylimidazolium, 1,4-dimethylimidazolium, 1,3,4-trimethylimidazolium, 1,4-dimethyl-3-ethylimidazolium, 3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium and 1-(prop-1-en-3-yl)-3-methylimidazolium.

As anions, it is in principle possible to use all anions.

The anions [Y]ⁿ⁻ of the ionic liquid is, for example, selected from among
the group of halides and halogen-comprising compounds of the formulae:
F⁻, Cl⁻, Br⁻, I⁻, BF₄⁻, PF₆⁻, AICl₄⁻, Al₂Cl₇⁻, Al₃Cl₁₀⁻, AlBr₄⁻, FeCl₄⁻, BCl₄⁻, SbF₆⁻, AsF₆⁻, ZnCl₃⁻, SnCl₃⁻, CuCl₂⁻, CF₃SO₃⁻, CF₃CO₂⁻, CCl₃CO₂⁻, CN⁻, SCN⁻, OCN⁻
the group of sulfates, sulfites and sulfonates of the general formulae:
SO₄²⁻, HSO₄⁻, SO₃²⁻, HSO₃⁻, R^{a}OSO₃⁻, R^{a}SO₃⁻
the group of phosphates of the general formulae
PO₄³⁻, HPO₄²⁻, H₂PO₄⁻, R^{a}PO₄²⁻, HR^{a}PO₄⁻, R^{a}R^{b}PO₄⁻
the group of phosphonates and phosphinates of the general formulae:
R^{a}HPO₃⁻, R^{a}R^{b}PO₂⁻, R^{a}R^{b}PO₃⁻
the group of phosphites of the general formulae:
PO₃³⁻, HPO₃²⁻, H₂PO₃⁻, R^{a}PO₃²⁻, R^{a}HPO₃⁻, R^{a}R^{b}PO₃⁻
the group of phosphonites and phosphinates of the general formulae:
R^{a}R^{b}PO₂⁻, R^{a}HPO₂⁻, R^{a}R^{b}PO⁻, R^{a}HPO⁻
the group of carboxylic acids of the general formula:
R^{a}COO⁻
the group of borates of the general formulae:
BO₃³⁻, HBO₃²⁻, H₂BO₃⁻, R^{a}R^{b}BO₃⁻, R^{a}HBO₃⁻, R^{a}BO₃²⁻, B(OR^{a})(OR^{b})(OR^{c})(OR^{d})⁻, B(HSO₄)⁻, B(R^{a}SO₄)⁻
the group of boronates of the general formulae:
R^{a}BO₂²⁻, R^{a}R^{b}BO⁻
the group of carbonates and carbonic esters of the general formulae:
HCO₃⁻, CO₃²⁻, R^{a}CO₃⁻
the group of silicates and silicic esters of the general formulae:
SiO₄⁴⁻, HSiO₄³⁻, H₂SiO₄²⁻, H₃SiO₄⁻, R^{a}SiO₄³⁻, R^{a}R^{b}SiO₄²⁻, R^{a}R^{b}R^{c}SiO₄⁻, HR^{a}SiO₄²⁻, H₂R^{a}SiO₄⁻, HR^{a}R^{b}SiO₄⁻
the group of halometallates of the general formula [M_{q}Halᵣ]^{s-} where M is a metal and Hal is fluorine, chlorine, bromine or iodine, q and r are positive integers and indicate the stoichiometry of the complex, and s is a positive integer and indicates the charge of the complex;

Here, R^{a}, R^{b}, R^{c} and R^{d} are each, independently of one another, hydrogen, C₁-C₃₀-alkyl, C₂-C₁₈-alkyl which may optionally be interrupted by one or more nonadjacent oxygen and/or sulfur atoms and/or one or more substituted imino groups, C₆-C₁₄-aryl, C₅-C₁₂-cycloalkyl or a five- or six-membered, oxygen-, nitrogen- and/or sulfur-comprising heterocycle, where two of them may also together form an unsaturated, saturated or aromatic ring which may optionally be interrupted by one or more oxygen and/or sulfur atoms and/or one or more unsubstituted or substituted imino groups, where the radicals mentioned may each be additionally substituted by suitable functional groups, aryl, alkyl, aryloxy, alkyloxy, halogen, heteroatoms and/or heterocycles.

Here, C₁-C₁₈-alkyl which may optionally be substituted by suitable functional groups, aryl, alkyl, aryloxy, alkyloxy, halogen, heteroatoms and/or heterocycles is, for example, methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, hexadecyl, octadecyl, 1,1-dimethylpropyl, 1,1-dimethylbutyl, 1,1,3,3-tetramethylbutyl, benzyl, 1-phenylethyl, α,α-dimethylbenzyl, benzhydryl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonylethyl, 2-ethoxycarbonylethyl, 2-butoxycarbonylpropyl, 1,2-di(methoxycarbonyl)ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, chloromethyl, trichloromethyl, trifluoromethyl, 1,1-dimethyl-2-chloroethyl, 2-methoxyisopropyl, 2-ethoxyethyl, butylthiomethyl, 2-dodecylthioethyl, 2-phenylthioethyl, 2,2,2-trifluoroethyl, 2-dimethylaminoethyl, 2-dimethylaminopropyl, 3-dimethylaminopropyl, 4-dimethylaminobutyl, 6-dimethylaminohexyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl or 6-ethoxyhexyl.

C₂-C₁₈-alkyl which may optionally be interrupted by one or more nonadjacent oxygen and/or sulfur atoms and/or one or more substituted or unsubstituted imino groups is, for example, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

When two radicals form a ring, these radicals can together form as fused-on building block, for example, 1,3-propylene, 1,4-butylene, 2-oxa-1,3-propylene, 1-oxa-1,3-propylene, 2-oxa-1,3-propenylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene.

The number of nonadjacent oxygen and/or sulfur atoms and/or imino groups is in principle not subject to any restrictions or is automatically restricted by the size of the radical or the cyclic building block. In general, there will be no more than 5 in the respective radical, preferably no more than 4 and very particularly preferably no more than 3. Furthermore, there is generally at least one carbon atom, preferably at least two carbon atoms, between any two heteroatoms.

Substituted and unsubstituted imino groups can be, for example, imino, methylimino, isopropylimino, n-butylimino or tert-butylimino.

The term “functional groups” refers, for example, to the following: di-(C₁-C₄-alkyl)amino, C₁-C₄-alkyloxycarbonyl, cyano or C₁-C₄-alkoxy. Here, C₁-C₄-alkyl is methyl, ethyl, propyl, isopropyl, n-butyl, sec-butyl or tert-butyl.

C₆-C₁₄-aryl which may optionally be substituted by suitable functional groups, aryl, alkyl, aryloxy, alkyloxy, halogen, heteroatoms and/or heterocycles is, for example, phenyl, tolyl, xylyl, α-naphthyl, β-naphthyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxymethylphenyl.

C₅-C₁₂-cycloalkyl which may optionally be substituted by suitable functional groups, aryl, alkyl, aryloxy, halogen, heteroatoms and/or heterocycles is, for example, cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl or a saturated or unsaturated bicyclic system such as norbornyl or norbornenyl.

A five- or six-membered, oxygen-, nitrogen- and/or sulfur-containing heterocycle is, for example, furyl, thiophenyl, pyrryl, pyridyl, indolyl, benzoxazolyl, dioxolyl, dioxyl, benzimidazolyl, benzthiazolyl, dimethylpyridyl, methylquinolyl, dimethylpyrryl, methoxyfuryl, dimethoxypyridyl, difluoropyridyl, methylthiophenyl, isopropylthiophenyl or tert-butylthiophenyl.

Preference for use as ionic liquids is given to 1-ethyl-3-methylimidazolium chloride, 1-ethyl-3-methylimidazolium methanesulfonate, 1-butyl-3-methylimidazolium chloride, 1-butyl-3-methylimidazolium methanesulfonate, methyl-tri-n-butylammonium methylsulfate, 1,2,4-trimethylpyrazolium methylsulfate, 1-ethyl-2,3-di-methylimidazolium ethylsulfate, 1,2,3-trimethylimidazolium methylsulfate, methylimidazolium chloride, methylimidazolium hydrogensulfate, 1-ethyl-3-methylimidazolium hydrogen-sulfate, 1-ethyl-3-methylimidazolium tetrachloroaluminate, 1-butyl-3-methylimidazolium hydrogensulfate, 1-butyl-3-methylimidazolium tetrachloroaluminate, 1-ethyl-3-methylimidazolium acetate, 1-butyl-3-methylimidazolium acetate, 1-ethyl-3-methylimidazolium ethylsulfate, 1-butyl-3-methylimidazolium methylsulfate, 1-ethyl-3-methylimidazolium thiocyanate, 1-butyl-3-methylimidazolium thiocyanate, choline acetate, choline salicylate, tris(2-hydroxyethyl)methylammonium methylsulfate and/or 1-ethyl-3-methylimidazolium diethylphosphate.

Particular preference is given to 1-ethyl-3-methylimidazolium methanesulfonate, 1-ethyl-2,3-dimethylimidazolium ethylsulfate, 1-ethyl-3-methylimidazolium diethylphosphate and/or 1-ethyl-3-methylimidazolium chloride.

Solution (I) comprising the polyurethane dissolved in ionic liquid can be spun by following generally customary and known processes, in particular the wet-spun process. In the wet-spun process, solution (I) is directed through a die, stretched and directed into a coagulation bath in which the fiber is formed by coagulation. The stretching endows the fiber with the desired linear density. The spinning temperature for solution (I) is typically between 40° C. and 140° C., preferably between 60° C. and 100° C. and particularly between 70° C. and 90° C.

The spinning viscosity of solution (I), i.e., its viscosity during spinning, is preferably between 0.1 Pa*s and 1000 Pa*s and preferably between 1 Pa*s and 100 Pa*s.

The fiber is obtained by spinning solution (I) into a coagulation bath. The coagulation bath comprises a nonsolvent, which causes the polyurethane in solution (I) to coagulate, preferably water. A mixture (II) of various nonsolvents can also be used as coagulant. Mixture (II) preferably comprises water. If appropriate, the mixture comprises an ionic liquid.

The weight ratio of water to ionic liquid in mixture (II) can be chosen within wide limits. The ratio is determined by the coagulation properties of water in the mixture and by the separability of the ionic liquid after leaving the coagulation bath. The maximum concentration of ionic liquid in water in mixture (II) depends on the coagulation properties of water in the ionic liquid. The minimal concentration of ionic liquid in water depends on the separabilities of water and ionic liquid. The minimum possible concentration of ionic liquid in water is 0% by weight.

The spinning speed is preferably between 1 and 1000 m/min, more preferably between 3 and 200 m/min and particularly between 3 and 100 m/min.

Before the spun fibers are wound onto bobbins, they are customarily treated with spin finishes. These spin finishes inhibit fiber coalescence on the package for example. Silicone oils are examples of such spin finishes.

Preferably, therefore, the fiber will be treated with a spin finish, preferably silicone oil, and subsequently wound up.

The present invention further provides the obtainable fibers, preferably spandex fibers.

After coagulation, the fibers, preferably the spandex fibers, usually still comprise a residual content of ionic liquids. It has emerged that, surprisingly, residual contents of ionic liquids in the fiber of less than 10% by weight, preferably less than 5% by weight and more preferably less than 3% by weight, all based on the total weight of the fiber comprising the ionic liquid, do not entail any observable disadvantageous properties for the fibers. On the contrary, owing to the ionic properties of the ionic liquids, the fibers frequently have antistatic properties. This prevents charge build-up on the fibers during further processing. The present invention therefore also provides antistatic spandex fibers comprising ionic liquid.

Preference is therefore also given to fibers comprising ionic liquid, the content of ionic liquid in the fiber being preferably less than 10% by weight, based on the total weight of the fiber comprising the ionic liquid.

The fibers preferably have a hardness between 60 Shore A and 95 Shore A. Preference is therefore also given to spandex fibers having a hardness in the range from 60 Shore A to 95 Shore A, preferably in the range from 65 Shore A to 90 Shore A and particularly in the range from 70 Shore A to 80 Shore A.

The linear density range in which the fibers are produced is preferably between 10 dtex to 3000 dtex, more preferably 80 dtex to 2000 dtex and particularly 160 dtex to 1500 dtex. dtex is a measure of the weight of a fiber 10 km in length. When it has a linear density of 1 dtex, a fiber 10 km in length weighs 1 g.

It has emerged that, surprisingly, ionic liquids have such good dissolving properties that already spun spandex fibers, whether produced by the wet-spun process or by the dry-spun process, can be redissolved in ionic liquids. Accordingly, solution (I) is also obtainable by dissolving a spandex fiber in an ionic liquid. The procedure is that the spandex fibers are introduced into the ionic liquid and dissolved at a temperature between 50 and 150° C., preferably 70 and 130° C. Advantageously, owing to the ionic character of the ionic liquid, spin finishes such as silicone oils are washed off the spandex fiber and easily separated from solution (I).

The resulting composition of matter can be spun as described above.

The present invention thus also provides processes for dissolving polyurethane, preferably spandex fibers, wherein polyurethane, preferably spandex fibers are dissolved in ionic liquids. The polyurethane, preferably the spandex fiber, can be dissolved at a temperature between 50 and 150° C. Spin finishes, preferably silicone oils, can be separated from the solution. The present invention thus further provides mixtures comprising ionic liquid and also polyurethane, preferably spandex fibers, dissolved therein.

### EXAMPLE 1

2500 g of a polytetrahydrofuran having a molar mass of 2000 g/mol are dissolved in 13 972 g of 1-ethyl-3-methylimidazolium methanesulfonate. Then, 574.1 g of 4,4′-MDI are added to the solution, followed by stirring for 40 min at 80° C.

### EXAMPLE 2

2000 g of the prepolymer solution from Example 1 are carefully added at 50° C. to a mixture of 6.66 g of ethylenediamine and 0.41 g of diethylamine in 4000 g of 1-ethyl-3-methylimidazolium methanesulfonate, followed by stirring for 30 min. Then, the solution is spun at 80° C. into an aqueous coagulation bath.

### EXAMPLE 3

20 g of a spandex fiber (Lycra®, Invista) are dissolved at 80° C. in 100 g of 1-ethyl-3-methylimidazolium methanesulfonate. The solution is subsequently cooled down to 30° C. Thereafter, the viscosity of the solution is adjusted, by addition of solvent, such that it is about 5000-5500 mPas at 30° C. The fiber is then spun into an aqueous coagulation bath.

### EXAMPLE 4

20 g of TPU of the type Elastollan® 2180 A 10 (Elastogran GmbH) are dissolved at 80° C. in 100 g of 1-ethyl-3-methylimidazolium methanesulfonate. The solution is subsequently cooled down to 30° C. Thereafter, the viscosity of the solution is adjusted, by addition of solvent, such that it is about 5000-5500 mPas at 30° C. The fiber is then spun into an aqueous coagulation bath.

### EXAMPLE 5

A prepolymer is prepared by reaction of PTHF 2000 (BASF Aktiengesellschaft) (2000 g), 4,4′-MDI (722.4 g) and 1,4-butanediol (40 g) by continuous stirring at 75° C. in 15 650 g of 1-ethyl-3-methylimidazolium methanesulfonate. The prepolymer is subsequently cooled down to 30° C. A mixture of 79.82 g of ethylenediamine and 4.92 g of diethyleneamine in 5000 g of 1-ethyl-3-methylimidazolium methanesulfonate is then gradually added to the solution. The mixture is subsequently allowed to react until the viscosity of the solution is 5000-5500 mPas. Thereafter, the solution is spun into water.

1-25. (canceled)

26. A process for producing fibers which comprises spinning a solution (I) comprising polyurethane into a coagulation bath, wherein said solution (I) comprises polyurethane dissolved in ionic liquid.

27. The process according to claim 26 wherein said solution (I) is produced by preparing the polyurethane in the ionic liquid.

28. The process according to claim 26 wherein said solution (I) is produced by reacting (a) isocyanate with (b) isocyanate-reactive compounds in the ionic liquid to prepare a prepolymer which is subsequently reacted with amines in said solution (I) and spun.

29. The process according to claim 26 wherein said solution (I) is produced by dissolving polyurethane in ionic liquids.

30. The process according to claim 29 wherein said solution (I) is produced by dissolving thermoplastic polyurethane in ionic liquids.

31. The process according to claim 29 wherein said solution (I) is produced by dissolving spandex in ionic liquids.

32. The process according to claim 27 wherein said polyurethane is based on the reaction of (a) isocyanate with (b) isocyanate-reactive compounds having a molecular weight between 500 g/mol and 10 000 g/mol and also (c) chain-extending agents in the presence or absence of (d) catalysts and/or (e) auxiliary materials.

33. The process according to claim 32 wherein said chain-extending agents (c) comprise aliphatic diamines.

34. The process according to claim 26 wherein said ionic liquid comprises a member selected from the group consisting of 1-ethyl-3-methylimidazolium methanesulfonate, 1-ethyl-2,3-dimethylimidazolium ethyl-sulfate, 1-ethyl-3-methylimidazolium diethylphosphate, 1-ethyl-3-methyl-imidazolium chloride and mixtures thereof.

35. The process according to claim 26 wherein said solution (I) comprising polyurethane is spun at a temperature between 40 and 140° C.

36. The process according to claim 26 wherein said solution (I) comprising polyurethane has a viscosity between 0.1 Pa*s and 1000 Pa*s during spinning.

37. The process according to claim 26 wherein said coagulation bath comprises water.

38. The process according to claim 26 wherein said spinning is effected at a speed between 1 m/min and 1000 m/min.

39. The process according to claim 26 wherein the fiber is treated with a spin finish and subsequently wound up.

40. A fiber obtainable according to claim 26.

41. The fiber according to claim 40 comprising spandex fiber.

42. The fiber according to claim 40 comprising ionic liquid.

43. The fiber according to claim 40 having a hardness between 60 Shore A and 95 Shore A.

44. The fiber according to claim 40 having a linear density between 10 dtex and 3000 dtex.

45. A process for dissolving polyurethane, which comprises dissolving polyurethane in ionic liquid and separating spin finishes from the solution.
